(19) United States
(12) Patent Application Publication
(10) Pub. No.: US 2022/0037705 A1
(43) Pub. Date: Feb. 3, 2022

(54) SMART BATTERY LOCATION TRACKING SYSTEM

(71) Applicants: Rifaz Ahamed Iqbal, Garland, TX (US); Khalid Ahmad, Richardson, TX (US)

(72) Inventors: Rifaz Ahamed Iqbal, Garland, TX (US); Khalid Ahmad, Richardson, TX (US)

(21) Appl. No.: 17/390,656

(22) Filed: Jul. 30, 2021

Related U.S. Application Data
(60) Provisional application No. 63/059,263, filed on Jul. 31, 2020.

(51) Int. Cl. H01M 10/42; H04W 4/029; G08B 3/10

(52) U.S. Cl. CPC H01M 10/4257; H01M 2010/4278; G08B 3/10; H04W 4/029

(57) ABSTRACT

A smart battery device that combines a power source with after-market location tracking technology to enable a battery-powered device to be located by sound or triangulation using radio frequency signals. The user may ping the invention via a smart phone application or other similar technology. which causes the invention to make an audible sound to assist in locating the invention. The user may triangulate the location of the device from the radio frequency signal. The device may be used with single use or rechargeable batteries. Case dividers separate the circuitry board from the battery source to prevent damage to either component. The invention will fit into devices powered by universal batteries without disassembling the device, except for opening the battery compartment. The user also benefits from location tracking technology for the device without the burden of unnecessary bulk caused by device carrying cases or location tracking internet enabled devices.

### FIELD OF THE INVENTION

The present invention relates to tracking systems, particularly tracking systems which may be integrated into existing devices and machines that are battery-powered.

### BACKGROUND

Many people, including both adults and children, use battery-powered devices for work and play. People use batteries for computer mouses, remote controls, cordless gadgets, portable devices, toys, tools as well as many other battery-powered devices. These devices are frequently misplaced, either due to their small size, an abundance of gadgets in the home or workplace, or even forgetfulness or disorganization. In addition to the actual battery-powered devices, additional batteries may be required for the remote control or other complementary tools of the main device. All of these items are subject to being misplaced eventually. Depending on the age of the battery-powered device or the technology available at its time of manufacture. the battery-powered device may not have locator technology built in or already incorporated into the device's structure or housing. In these instances, a lost battery-powered device may remain missing for hours, day, weeks, months, or forever, depending on how successful the manual and often tedious search process is for the user. Other location tracking devices have an independent power source, which requires the user to provide power to the location tracking device as well as the battery-powered device the user wants to track. It's unlikely that the dual battery sources will ever power down or lose function at the same time so the user must monitor them both and prepare for replacement at different times.

The present invention is an improvement on currently existing location tracking technology. Whenever a user wants to add tracking technology to a battery-powered device as an aftermarket feature, the user can attach the tracker to the phone case or the exterior of the device or location tracking devices connected to the internet or Internet of Things (IoT) devices. If the tracker is placed inside the battery-powered device, the device may become inoperable if the device is not reassembled properly. Currently there are limited options to add location tracking technology if battery operated devices don't have the feature already built in. If there are any options. they're usually specific to the model of the device, possibly bulky and possibly expensive and cost prohibitive and they can be lost or misplaced easily. Location tracking add-ons are usually bulky and use more power consuming technology like cellular or WIFI that needs to be connected to the device via a hub or a smartphone. The other options for adding after-market location tracking also need to be powered with their own power source, adding on to the bulk.

A user can also add a tracking tag that uses radio frequency technology (RF) like Bluetooth technology to tag the battery-operated device. The tracking tag may be attached to the exterior of the device with adhesive but this type of tracking tag is susceptible to becoming dislodged. A tracking tag that is hanging from a key chain or other portable device is at risk of becoming detached from the tracked device. There is also an issue of powering both the tag and the receiver, which will not work if the power is drained. The size of the tracking tag also may not be compatible with the battery-operated device. As with all battery-powered devices, the batteries will age and no longer power the device sufficiently or at all. When it's time to replace batteries, the user simply opens the case, removes the old batteries and replaces with fresh batteries. The present invention will fit into devices that use universal batteries, and therefore add tracking technology, without disassembling the battery-powered device (and risking malfunction once the battery-powered device is reassembled) except for opening the battery compartment (which a user of any battery-powered device expects to do as batteries are drained) and without adding unnecessary bulk to the battery-powered device.

### OBJECTIVES

An object of one embodiment of the present disclosure is to integrate aftermarket location tracking technology into an existing device that does not have tracking technology.

Another object of the present disclosure is to enable an existing device with location tracking capabilities through replacement of universal battery with a smart battery system with location tracking.

Another object of the present disclosure is to add tracking technology to a battery-powered device wherein both devices utilize a single power source.

Another object of the present disclosure is to add aftermarket tracking technology to a device that is fits within the battery-powered device, is affordable. and is not susceptible to being misplaced.

### SUMMARY

The present disclosure is for a smart battery system which enhances an existing battery-powered device with location tracking by the replacement of a universal battery with the present smart battery system, which consists of a power source or battery, circuitry board and a enclosure or casing unit to house the power source and circuitry board. If the battery-powered device has no locator technology built in, finding the device can be a manual and oftentimes tedious process. The present invention addresses this problem by replacing the existing standard or universal battery with a smart battery system enabled with tracking technology. The present smart battery system features universal integration into the main battery-powered device, wherein any battery-powered device that takes a certain battery size will automatically become trackable without adding a separate tracking device, such as an aftermarket tracker to the exterior, which may increase hulk, expense and is at risk of being lost, which defeats the purpose of the tracker.

Since battery-powered devices such as remote controls and toys are frequently misplaced, it would be beneficial to a user if these battery-powered devices were enabled with locator technology or tracking technology without adding bulkiness to the device and without requiring additional disassembly of the device, which could impact its functionality. This smart battery system invention has a built-in buzzer or circuitry to triangulate the location that will be triggered with an electronic wireless signal. A cellular phone, smart phone, smart tv, charging dock enabled with smart battery system trigger, or other similar device with the appropriate wireless trigger may be used to ping the battery. The present smart battery system invention will fit into and is compatible with devices that take universal batteries without taking the devices apart, except for opening the battery compartment, and without having to add bulky options like phone cases, other device cases or exterior protective elements or location tracking internet enabled devices.

The smart battery system invention may be used with rechargeable batteries or single use, disposable batteries inside the casing unit or case of the smart battery system. With rechargeable batteries, the user will need to charge the rechargeable battery prior to using the rechargeable battery with the smart battery system invention. Alternatively, the rechargeable battery may be irremovably placed inside the smart battery system invention and recharged via the voltage regulator on the PCB. Disposable batteries, such as a standard AA or AAA, are ready to use immediately with the smart battery system invention. The user will insert the smart battery system invention (with either a rechargeable battery or a single use battery inserted into the case of the smart battery system invention) into a battery-powered device that the user desires to add location tracking technology in the event the battery-powered device is likely to be misplaced someday, like a television remote. In addition to powering the device, the battery also powers the circuitry board to help with location detection. When the user needs to locate the device, the user would trigger the wireless electronic signal via a smart device such as cellular phone, smart watch, smart television, or a dedicated docking station. This will cause the battery to either send an audible signal so the user can detect it, or send a radio frequency signal so an external device, like a cellular phone or other smart device, can triangulate the battery's position. The smart battery app will identify and then connect the smart device to the smart battery system invention via Bluetooth and the smart battery app will ping the buzzer on the smart battery system invention.

In use, the smart battery circuitry is available on a PCB, printed circuitry board, which has been manufactured and assembled prior to use of the smart battery system invention. The PCB will be connected to the power source, and the entire assembly will be enclosed in the smart battery system invention's case. The smart battery system invention can either use an audible buzzer, wireless trigger or the circuitry for electronic triangulation, or a combination of these elements. The remaining components are essential to the functionality of the smart battery system invention. In this embodiment, the PCB has two sides, a first side and a second side, opposite from the first side. The first side contains the positive terminal solder pad at one end and the negative terminal solder pad at the opposite end of the PCB. The second side of the PCB contains the Microcontroller, radio frequency (RF) antenna circuit, Voltage Regulator, and the buzzer.

The PCB components can be rearranged inside the smart battery case, but the components should maintain the same functionality as a whole. For ideal functionality, the buzzer should face outwards and be aligned with the series of openings or buzzer holes on the case to maximize the output sounds of the buzzer. However, buzzer holes can be placed anywhere along the case as long as the buzzer on the PCB is in a similar position. The positive terminal and negative terminal may be inside or outside of the case. When the terminals are inside the case, the terminal will have direct contact with the battery. If the terminal is outside the case, the terminal may be connected to the battery via a conductor, such as a wire. Certain components such as the Positive Terminal, Negative Terminal, Microcontroller, radio frequency (RF) antenna circuit, Voltage Regulator, Positive terminal solder pad, and Negative terminal solder pad must be placed carefully to complete the circuit of the smart battery system invention and power the invention. The case dividers separate the PCB and battery power source to prevent any damage from mechanical stress caused by insertion and removal of the battery or power source or jostling of the contents of the case during use or movement of the battery-powered device.

The microcontroller of the smart battery system is located on the PCB and is a small microcomputer that serves as the brains or operating center of the smart battery system and handles inputs and outputs from the RF antenna, voltage regulator and buzzer. The radio frequency antenna circuit is also on the PCB and receives electric signals from the application and handles communication between the smart battery system and the triggering device. The voltage from the battery may be 1.5V DC. The voltage regulator is also on the PCB and serves to increase or decrease the voltage to the other components that require a different voltage level.

The case of the smart battery system is comprised of the cylindrical body of the case, a circular, top wall of the case with an opening for the positive terminal, a C-shaped bottom wall of the case for the negative terminal, a pair of case dividers positioned at the open end of the C-shaped bottom wall, a series of openings or buzzer holes on the rear side of the case body, and a battery opening on the opposite of the case. To use this smart battery system invention, a user needs to charge the battery, if battery power source needs charging, and then insert battery power source into the smart battery system invention case through the battery opening of the case before inserting the smart battery system invention into the battery-powered device to which the user wants to add the after-market feature of location tracking. Additionally, this invention can be used to locate any device that is powered by removable batteries, especially if additional add-ons for location detection aren't ideal. The Positive terminal can go inside before the battery power source, or the positive terminal can be on top of the battery power source, depending on the configuration of the components of the smart battery system invention. However, the positive terminal must be connected to both the battery power source and the top of the PCB. The PCB slides into the flat side, next to the speaker holes. A pair of case dividers separate the battery power source from the PCB inside the case. The case dividers (casing unit dividers) are substantially the same length as the case, flat and located inside the case on opposite sides of the buzzer holes. The PCB is positioned on one side of the pair of case dividers and the battery power source is positioned on the opposite side of the case dividers to provide separation and prevent damage to either component (PCB and battery) from any jostling or physical impacts to the smart battery system invention. The pair of case dividers are positioned at the open side of the C-shaped case lower wall of the case.

To activate the buzzer and/or the triangulation system, the user may [symbol] download a custom application that is connected to the smart battery system invention. The triangulation system measures the strength of the signal from the RF antenna circuit and coordinates with the application software to determine the distance and direction of the battery-powered device based on the strength of the signal. A user may choose to register or connect multiple smart battery systems to the application in order to have the ability to locate multiple devices operated by the user. Once a smart battery system has been registered to the user's account in the application, the user may select a specific smart battery system and activate the buzzer on that smart battery system to locate the device holding that specific smart battery system. Other technical features may be readily apparent to those skilled in the art from the following figures and descriptions.

### BRIEF DESCRIPTION OF THE DRAWINGS

For a more complete understanding of this disclosure and its features, reference is now made to the following descriptions, taken in conjunction with the accompanying drawings. in which:

FIG. 1 shows the front side perspective view of invention with battery inserted.

FIG. 2 shows rear side perspective view of the invention.

FIG. 3 shows the front side perspective view of the invention with battery uninserted.

FIG. 4 shows the rear side perspective view of the invention with battery and PCB uninserted.

FIG. 5 shows the PCB outside the case and the case divider.

### Reference Numbers

1. Case or casing unit

2. Battery Power Source

3. Positive Terminal

4. Negative Terminal

5. PCB (printed circuitry board)

6. Microcontroller

7. Buzzer, triangulation or wireless circuity

8. RF antenna circuit

9. Voltage Regulator

10. Positive terminal solder pad

11. Negative terminal solder pad

12. Speaker/Buzzer holes

13. Battery opening of case

14. Bottom wall of case

15. Case dividers

16. Top wall of case

### DETAILED DESCRIPTION

The present disclosure generally provides a smart battery to replace standard batteries in battery-powered device with the addition of location tracking. The battery or source of power 2 fuels and connects to the Printed Circuit Board—PCB 5 via the positive terminal 3 and negative terminal 4. The PCB 5 has the microcontroller 6, the buzzer, triangulation or wireless circuitry 7, an optional voltage regulator 9, and the RF antenna 8 soldered onto the PCB. The PCB 5 also has a positive solder pad 10 and negative terminal 11 solder pad, which connect to the positive terminal and negative terminal, respectively, in use. The positive terminal 3 is attached to the PCB via the positive terminal solder pad 10. Similarly, the negative terminal 4 is attached to the PCB via the negative terminal solder pad 11. The connections complete the circuitry of the smart battery system. The invention's circuitry is powered by the power source 2 via the positive terminal and the negative terminal.

For a rechargeable version of the smart battery system invention, an optional voltage regulator 9 can be added to charge the power source 2. The entire smart battery system invention system is encased in a case or enclosure 1 with the positive terminal 3 and negative terminal 4 mechanically attached to the case. The user may insert and remove the battery or power source without movement of the terminals. The PCB 5 will be positioned adjacent to the battery 2, inside the case 1. The lower portion of the case 1 has speaker holes 12 to project the buzzer sound better. The PCB will be soldered on to the positive and negative terminals and can slide into the case or enclosure adjacent to the case divider. The PCB will rest adjacent to the power source, with the case divider creating a separation between the PCB and battery-power source. If the battery power source is rechargeable, it may be permanently fixed into the smart battery system invention case or enclosure and the battery opening may be closed since the user will not need to remove the battery. For single use batteries, the battery power source may be manually removed. The case of the smart battery system is comprised of the cylindrical body of the case, a circular, top wall of the case with an opening for the positive terminal, a C-shaped bottom wall of the case for the negative terminal, a pair of case dividers positioned at the open end of the C-shaped bottom wall, a series of openings or buzzer holes on the rear side of the case body, and a battery opening on the opposite of the case.

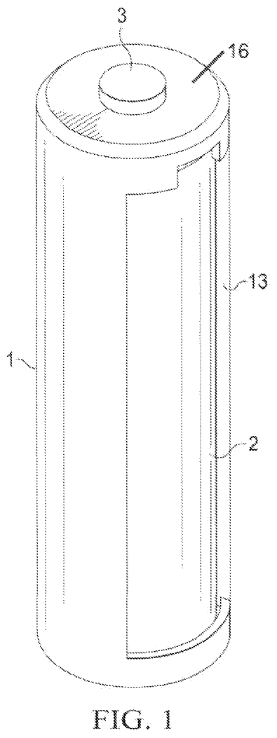

FIG. 1 shows the front side perspective view of smart battery system invention with battery 2-or power source inserted. In this view, the positive terminal 3 is inserted into the top wall of the case 16, the negative terminal 4 at the bottom wall of the case 14 is not visible in this view. The side of the case 1 where the battery 2 is inserted and removed remains open at the battery opening of the case 13.

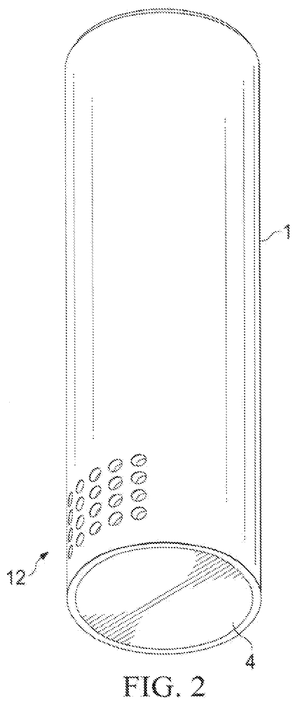

FIG. 2 shows rear side perspective view of the smart battery system invention. In this view, the negative terminal 4 is at the bottom wall of the case 14. The speaker or buzzer holes 12 are on the side of the case 1 opposite the battery opening of the case 13. Inside the case 1, the buzzer 7 (not pictured) is adjacent to the buzzer holes 12 to maximize sound output. The PCB 5 is adjacent to the case divider 14 and the battery 2 power source is on the opposite of the case divider 15 (not visible in this view).

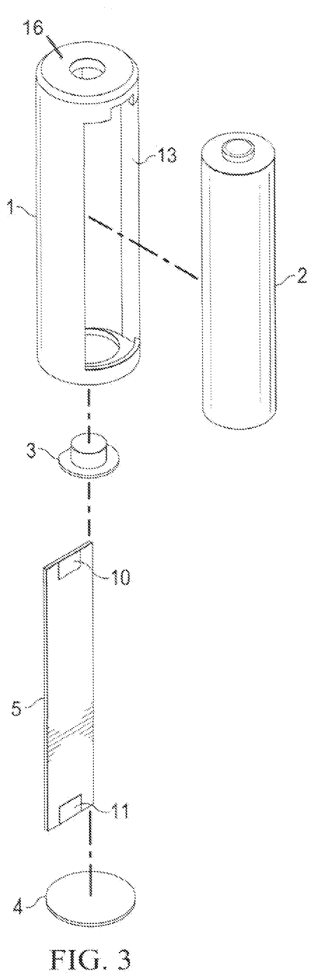

FIG. 3 shows the front side perspective view of the invention with battery 2 outside of the case 1. In this expanded view, the battery power source 2 is outside of the case 1 and adjacent to the battery opening of the case 13. The case 1 is pictured with openings for both the positive terminal at the top wall of the case 16 and the negative terminal at the bottom wall of the base 14. Additional components of the smart battery system invention include the following: the positive terminal 3, shown immediately below the case 1 and above the printed circuit board (PCB 5), which may be placed adjacent to the positive end of the battery-power source 2 prior to inserting the battery 2 into the case 1. The negative terminal 4, shown immediately below the printed circuit board (PCB 5), may be placed adjacent to the negative end of the battery power source 2 prior to inserting the battery 2 into the case 1. The printed circuit board (PCB 5) includes the following components: positive terminal solder pad 10 at the upper edge of the PCB 5, and negative terminal solder pad 11 at the lower edge of the PCB 5. This view of the smart battery system components shows the rear surface of the PCB 5 with positive terminal solder pad 10 and negative terminal solder pad 11.

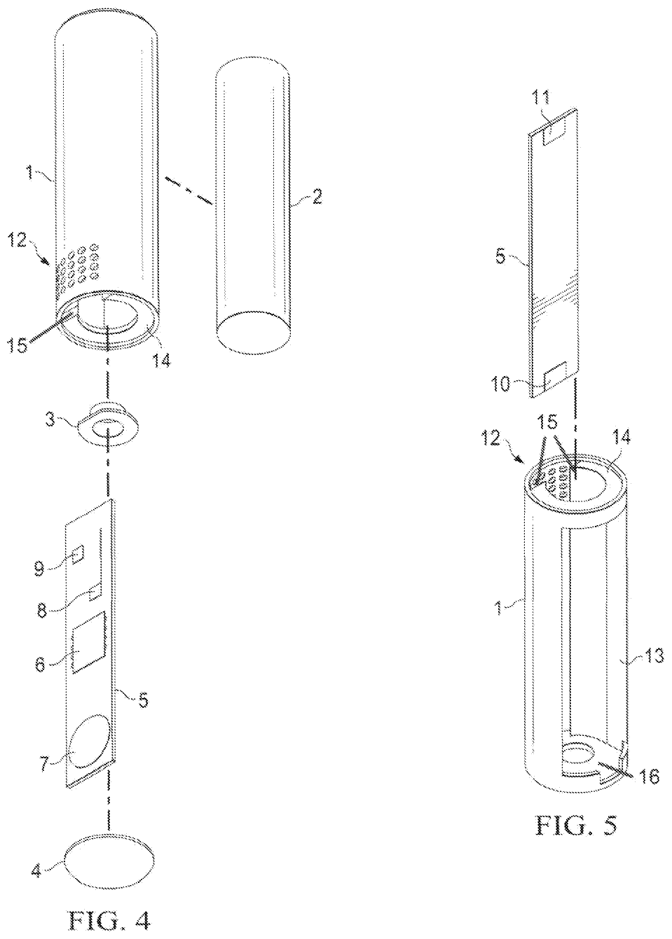

FIG. 4 shows the rear side perspective view of the invention with battery 2 and PCB 5 uninserted. In this expanded view, the battery 2/power source is outside of the case 1 and shown near the battery opening of the case 13. This rear view of the smart battery system invention shows the speaker or buzzer holes 12 at the bottom wall of the case 14 or enclosure. The case 1 is pictured with opening for the negative terminal at the bottom wall of the case 14. The positive terminal 3, shown immediately below the case 1 and above the printed circuit board (PCB 5), may be placed adjacent to the positive end of the battery power source prior to inserting the battery 2 into the case 1. The negative terminal 4, shown immediately below the printed circuit board (PCB 5), may be placed adjacent to the negative end of the battery 2-power source prior to inserting the battery 2 into the case 1. This view of the smart battery system invention shows the front surface of the PCB 5, which includes the following components, which are soldered to the PCB 5 in no particular configuration except that the buzzer 7 should be in a position to be adjacent to the buzzer holes of the case 12. The other components attached to the PCB 5 include a voltage regulator 9, an RF antenna circuit 8, and a microcontroller 6.

FIG. 5 shows the PCB 5 outside the case 1. In this view, the rear surface of the PCB 5 with the positive terminal solder pad 10 is positioned above the bottom wall of the case 14 with the buzzer holes 12 on the rear surface of the case 1. The negative terminal opening end of the case 1 is shown at the bottom wall of the case 14 and the positive terminal opening end of the case 1 is shown at the top wall of the case 16. The bottom wall of the case 1 is shown as an incomplete circle (C shape) with a pair of case dividers 15 at the open end of the bottom wall of the case 14. The case dividers 15 are flat surfaces inside the case that span from near the lower end of the case 1, where the negative terminal opening of bottom wall of the case 14 is positioned, up to the upper end of the case 1, where the positive terminal opening of the top wall of the case 16 is positioned. The case divider 15 provides a barrier or resting place for the PCB 5 inside the case 1 and prevents the power source battery 2 inside the case 1 from striking into the PCB 5 inside the case 1. The PCB 5 is inserted into the open side of the C-shaped bottom wall the case 14. This case divider 15 prevents excessive contact and potential damage by the possible jostling of the PCB 5 and battery 2 inside the case 1. Once the PCB 5 and power source battery 2 are inserted inside the smart battery case 1, the negative terminal 4 will be attached to the end of the smart battery 2 case 1 to close the invention and secure the battery power source 2, PCB 5 and other interior components of the smart battery system invention.

What is claimed is:

1. A battery system. wherein said system is comprised of:
A power source;
An enclosure device;
A circuitry board;
A triggering system.

2. The battery system of claim 1, wherein said enclosure device is comprised of:
A casing unit;
A positive terminal; and
A negative terminal.

3. The battery system of claim 2, wherein said circuitry board is comprised of the following components:
A microcontroller;
A buzzer;
A radio frequency antenna circuit;
A voltage regulator. which controls the amount of power accessible by components of said circuitry board;
A positive terminal solder pad;
A negative terminal solder pad; and
A series of holes.

4. The battery system of claim 3, wherein an external wireless application sends a signal to said microcontroller to activate said buzzer to assist in locating said battery system.

5. The battery system of claim 4, wherein said casing unit is a cylindrical tube with an upper partially open end and a lower partially open end, wherein said upper open end of said casing unit is suitable for the insertion of said positive terminal. wherein said lower open end is suitable for the insertion of said negative terminal, wherein a first side of said casing unit is open, wherein a second side of said casing unit is closed, wherein a series of holes are located on said second side of said casing unit.

6. The battery system of claim 5. wherein said casing unit is further comprised of at least two casing unit interior dividers positioned inside of said casing unit, wherein said casing unit divider spans the length of said casing unit from said upper open end of said casing unit to said lower open end of said casing unit, wherein a first side of said casing unit divider is flat, wherein a second side of said casing unit divider is flat.

7. The battery system of claim 6, wherein said microcontroller is a computer system that processes inputs and outputs from said circuitry board and said components of said circuitry board.

8. The battery system of claim 7, wherein said radio frequency antenna circuit handles communication between said battery system and said triggering system.

9. The battery system of claim 8, wherein said buzzer of said circuity board is adjacent to the interior surface of said series of holes on said second side of said casing unit.

10. The battery system of claim 2, wherein said circuitry board is comprised of:
A microcontroller;
A wireless trigger circuity;
A radio frequency antenna circuit;
A voltage regulator;
A positive terminal solder pad;
A negative terminal solder pad; and
A series of holes.

11. The battery system of claim 1, wherein said triggering system may be selected from the group consisting of smart phone application, wireless signal, antenna signal, radio signal, buzzer signal, and location tracking docking station.

12. The battery system of claim 1 wherein said power source may be selected from the group consisting of: a universal cell battery, a disposable electrochemical cell battery, and a rechargeable electrochemical cell battery.

13. The battery system of claim 1, wherein said power source may be selected from the group consisting of: a universal battery, a disposable battery, and a rechargeable battery.

14. A method of adding location tracking technology to a battery-powered personal device via a smart battery system comprised of the following steps:
Attach positive terminal to positive end of universal battery;
Insert battery into casing unit of smart battery system;
Insert printed circuity board into casing unit of smart battery system;
Attach negative terminal to negative end of universal battery;
Insert universal battery with positive terminal and negative terminal into smart battery case;
Activate buzzer of smart battery system via wireless activation system to locate said personal device.

15. A method of adding location tracking technology to a battery-powered personal device via a smart battery system comprised of the following steps:
Attach positive terminal to positive end of universal battery;
Insert battery into casing unit of smart battery system;
Insert printed circuity board into casing unit of smart battery system;
Attach negative terminal to negative end of universal battery;
Insert universal battery with positive terminal and negative terminal into smart battery case; and
Activate radio frequency antenna of smart battery system via wireless activation system to locate said personal device.
